(19) United States
(12) Patent Application Publication
(10) Pub. No.: US 2015/0379329 A1
(43) Pub. Date: Dec. 31, 2015

(54) MOVEMENT PROCESSING APPARATUS, MOVEMENT PROCESSING METHOD, AND COMPUTER-READABLE MEDIUM

(71) Applicant: CASIO COMPUTER CO., LTD., Tokyo (JP)

(72) Inventors: Masaaki SASAKI, Tokyo (JP); Tetsuji MAKINO, Tokyo (JP)

(73) Assignee: CASIO COMPUTER CO., LTD., Tokyo (JP)

(21) Appl. No.: 14/666,288

(22) Filed: Mar. 23, 2015

(30) Foreign Application Priority Data
Jun. 30, 2014 (JP) 2014-133722

(51) Int. Cl. G06K 9/00; G06T 13/40

(52) U.S. Cl. CPC G06K 9/00268; G06K 9/00255; G06K 9/00315; G06T 13/40; G06K 2009/00322

(57) ABSTRACT

In order to allow main parts of a face to move more naturally, a movement processing apparatus includes a face feature detection unit configured to detect features related to a face from an acquired image including the face, an object feature specifying unit configured to specify features of an object having the face included in the image, based on the detection result of the features related to the face, and a movement condition setting unit configured to set control conditions for moving the main parts forming the face included in the image, based on the specified features of the object.

### BACKGROUND

1. Technical Field

The present invention relates to a movement processing apparatus, a movement processing method, and a computer-readable medium.

2. Related Art

In recent years, a so-called “virtual mannequin” has been proposed, in which a video is projected on a projection screen formed in a human shape (see JP 2011-150221 A, for example). A virtual mannequin provides a projection image with presence as if a human stood there. This can produce novel and effective display at exhibitions and the like.

In order to enrich face expression of such a virtual mannequin, there is known a technology of expressing movements by deforming main parts (eyes, mouth, and the like, for example) forming a face in an image such as a photograph, an illustration, or a cartoon. Specific examples include a method of generating an animation by deforming a three-dimensional model so as to realize intentional and unintentional movements (see JP 2003-123094 A, for example), and a method of realizing lip-sync by changing the shape of a mouth by each consonant or vowel of a pronounced word (see JP 2003-58908 A, for example).

Meanwhile, if moving modes of the main parts of a face to be processed, such as a degree of deformation applied to the main parts, are designated manually one by one, the work load increases. As such, it is not practical.

On the other hand, there is also a method of determining a moving mode such as a deformation amount of the main parts, according to the size of a face area and the size of the main parts relative to the face area. However, if the main parts are deformed uniformly, there is a problem that unnatural deformation is caused, whereby viewers feel a sense of incongruity.

### SUMMARY

The present invention has been developed in view of such a problem. An object of the present invention is to allow the main parts of a face to move more naturally.

A movement processing apparatus including:

an acquisition unit configured to acquire an image including a face; and

a control unit configured to:

detect a feature related to the face from the image acquired by the acquisition unit;

specify a feature of an object having the face, based on the detection result; and

set a control condition for moving a main part forming the face, based on the specified feature of the object.

According to the present invention, it is possible to allow the main parts of a face to move more naturally.

### BRIEF DESCRIPTION OF THE DRAWINGS

FIG. 1 is a block diagram illustrating a schematic configuration of a movement processing apparatus according to an embodiment to which the present invention is applied;

FIG. 2 is a flowchart illustrating an exemplary movement according to face movement processing by the movement processing apparatus of FIG. 1;

FIG. 3 is a flowchart illustrating an exemplary movement according to main part control condition setting processing in the face movement processing of FIG. 2;

FIG. 4A is a diagram for explaining the main part control condition setting processing of FIG. 3; and

FIG. 4B is a diagram for explaining the main part control condition setting processing of FIG. 3.

### DETAILED DESCRIPTION

Hereinafter, specific modes of the present invention will be described using the drawings. However, the scope of the invention is not limited to the examples shown in the drawings.

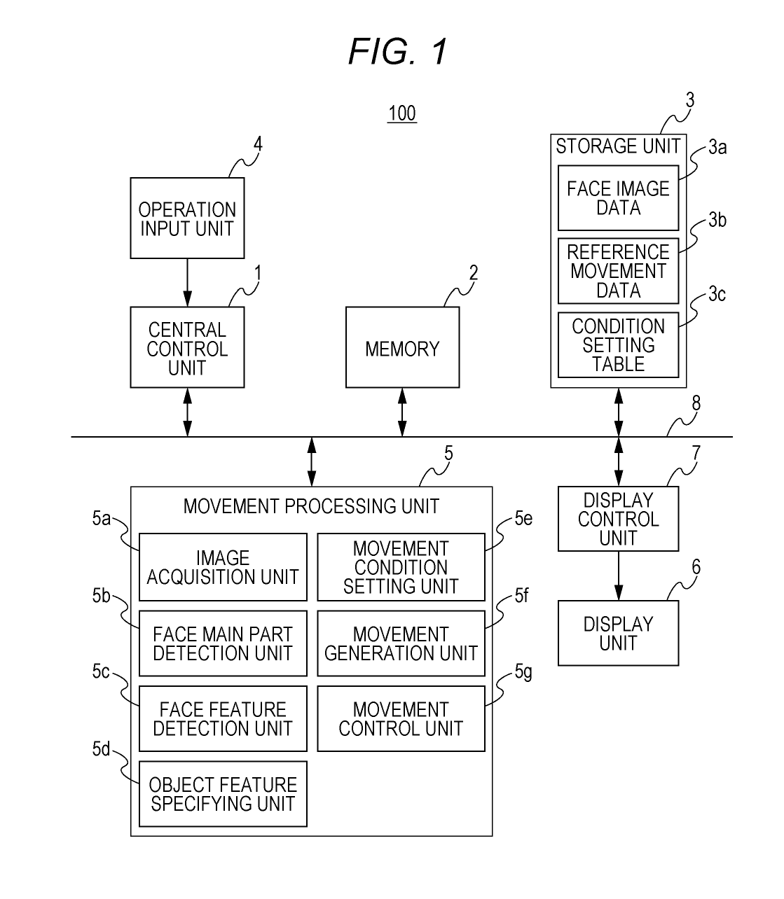

FIG. 1 is a block diagram illustrating a schematic configuration of a movement processing apparatus 100 of a first embodiment to which the present invention is applied.

The movement processing apparatus 100 is configured of a computer or the like such as a personal computer or a work station, for example. As illustrated in FIG. 1, the movement processing apparatus 100 includes a central control unit 1, a memory 2, a storage unit 3, an operation input unit 4, a movement processing unit 5, a display unit 6, and a display control unit 7.

The central control unit 1, the memory 2, the storage unit 3, the movement processing unit 5, and the display control unit 7 are connected with one another via a bus line 8.

The central control unit 1 controls respective units of the movement processing apparatus 100.

Specifically, the central control unit 1 includes a central processing unit (CPU; not illustrated) which controls the respective units of the movement processing apparatus 100, a random access memory (RAM), and a read only memory (ROM), and performs various types of control operations according to various processing programs (not illustrated) of the movement processing apparatus 100.

The memory 2 is configured of a dynamic random access memory (DRAM) or the like, for example, and temporarily stores data and the like processed by the respective units of the movement processing apparatus 100, besides the central control unit 1.

The storage unit 3 is configured of a non-volatile memory (flash memory), a hard disk drive, and the like, for example, and stores various types of programs and data (not illustrated) necessary for operation of the central control unit 1.

The storage unit 3 also stores face image data 3a.

The face image data 3a is data of a two-dimensional face image including a face. The face image data 3a may be image data of an image including at least a face. For example, the face image data 3a may be image data of a face only, or image data of the part above the chest. Further, a face image may be a photographic image, or one drawn as a cartoon, an illustration, or the like.

It should be noted that a face image according to the face image data 3a is just an example, and is not limited thereto. It can be changed in any way as appropriate.

The storage unit 3 also stores reference movement data 3b.

The reference movement data 3b includes information showing movements serving as the basis for expressing movements of respective main parts (eyes, mouth, and the like, for example) of a face. Specifically, the reference movement data 3b is defined for each of the main parts, and includes information showing movements of a plurality of control points in a given space. For example, information representing position coordinates (x, y) of a plurality of control points in a given space and deformation vectors and the like are aligned along the time axis.

That is, in the reference movement data 3b of a mouth, for example, a plurality of control points corresponding to the upper lip, the lower lip, and the right and left corners of the mouth are set, and deformation vectors of these control points are defined.

The storage unit 3 also includes a condition setting table 3c.

The condition setting table 3c is a table used for setting control conditions in face movement processing. Specifically, the condition setting table 3c is defined for each of the respective main parts. Further, the condition setting table 3c is defined for each of the features (for example, smiling level, age, gender, race, and the like) of an object, in which the content of a feature (for example, smiling level) and a correction degree of reference data (for example, correction degree of an opening/closing amount of a mouth opening/closing movement) are associated with each other.

The operation input unit 4 includes operation units (not illustrated) such as a keyboard, a mouse, and the like, configured of data input keys for inputting numerical values, characters, and the like, an up/down/right/left shift key for performing data selection, data feeding operation, and the like, various function keys, and the like. According to an operation of the operation units, the operation input unit 4 outputs a predetermined operation signal to the central control unit 1.

The movement processing unit 5 includes an image acquisition unit 5a, a face main part detection unit 5b, a face feature detection unit 5c, an object feature specifying unit 5d, a movement condition setting unit 5e, a movement generation unit 5f, and a movement control unit 5g.

It should be noted that while each unit of the movement processing unit 5 is configured of a predetermined logic circuit, for example, such a configuration is just an example, and the configuration of each unit is not limited thereto.

The image acquisition unit 5a acquires the face image data 3a.

That is, the image acquisition unit (acquisition unit) 5a acquires the face image data 3a of a two-dimensional image including a face which is a processing target of face movement processing. Specifically, the image acquisition unit 5a acquires the face image data 3a desired by a user, which is designated by a predetermined operation of the operation input unit 4 by the user, among a given number of units of the face image data 3a stored in the storage unit 3, as a processing target of face movement processing, for example.

It should be noted that the image acquisition unit 5a may acquire face image data from an external device (not illustrated) connected via a communication control unit not illustrated, or acquire face image data generated by being captured by an imaging unit not illustrated.

The face main part detection unit 5b detects main parts forming a face from a face image.

That is, the face main part detection unit 5b detects main parts such as right and left eyes, nose, mouth, eyebrows, and face contour, from a face image of face image data acquired by the image acquisition unit 5a, through processing using active appearance model (AAM), for example.

Here, AAM is a method of modeling a visual event, which is processing of modeling an image of an arbitrary face area. For example, the face main part detection unit 5b registers, in a given registration unit, statistical analysis results of positions and pixel values (for example, luminance values) of predetermined feature parts (for example, corner of an eye, tip of nose, face line, and the like) in a plurality of sample face images. Then, with use of the positions of the feature parts as the basis, the face main part detection unit 5b sets a shape model representing a face shape and a texture model representing an “appearance” in an average shape, and performs modeling of a face image using such models. Thereby, the main parts such as eyes, nose, mouth, eyebrows, face contour, and the like are modeled in the face image.

It should be noted that while AAM is used in detecting the main parts, it is just an example, and the present invention is not limited to this. For example, it can be changed to any method such as edge extraction processing, anisotropic diffusion processing, or template matching, as appropriate.

The face feature detection unit 5c detects features related to a face.

That is, the face feature detection unit 5c detects features related to a face from a face image acquired by the image acquisition unit 5a.

Here, features related to a face may be features directly related to a face such as features of the main parts forming the face, or features indirectly related to a face such as features of an object having a face, for example.

Further, the face feature detection unit 5c quantifies features directly or indirectly related to a face by performing a given operation, to thereby detect them.

For example, the face feature detection unit 5c performs a given operation according to features of a mouth, detected as a main part by the face main part detection unit 5b, such as a lifting state of the right and left corners of the mouth, an opening state of the mouth, and the like, and features of eyes such as the size of the pupil (iris area) in the eye relative to the whole of the face, and the like. Thereby, the face feature detection unit 5c calculates an evaluation value of the smile of the face included in the face image to be processed.

Further, the face feature detection unit 5c extracts feature quantities such as average or distribution of colors and lightness, intensity distribution, and color difference or lightness difference from a surrounding image, of a face image to be processed, and by applying a well-known estimation theory (see JP 2007-280291 A, for example), calculates evaluation values such as age, gender, race, and the like of an object having a face, from the feature quantities. Further, in the case of calculating an evaluation value of age, the face feature detection unit 5c may take into account wrinkles of a face.

It should be noted that the method of detecting smile, age, gender, race, and the like described above is an example, and the present invention is not limited thereto. The method can be changed in any way as appropriate.

Further, smile, age, gender, race, and the like exemplarily shown as features related to a face are examples, and the present invention is not limited thereto. The features can be changed in any way as appropriate. For example, as face image data, if image data of a human face wearing glasses, a hat, or the like is used as a processing target, such an accessory may be used as a feature related to the face. Further, if image data of a part above the chest is used as a processing target, a feature of the clothes may be used as a feature related to the face. Furthermore, in the case of a woman, makeup of the face may be used as a feature related to the face.

The object feature specifying unit 5d specifies features of an object having a face included in a face image.

That is, the object feature specifying unit 5d specifies features of an object having a face (for example, a human) included in a face image, based on the detection result of the face feature detection unit 5c.

Here, features of an object include a smiling level, age, gender, race, and the like of the object, for example. The object feature specifying unit 5d specifies at least one of them.

For example, in the case of a smiling level, the object feature specifying unit 5d compares the evaluation value of the smile, detected by the face feature detection unit 5c, with a plurality of thresholds to thereby relatively evaluate and specify the smiling level. For example, the smiling level is higher if the object smiles largely like a broad smile, while the smiling level is lower if it smiles slightly like a faint smile.

Further, in the case of age, for example, the object feature specifying unit 5d compares the evaluation value of the age detected by the face feature detection unit 5c with a plurality of thresholds, and specifies an age group such as teens, twenties, thirties, or the like, or a segment to which the age belongs such as infant, child, young, adult, elderly, or the like.

Further, in the case of gender, for example, the object feature specifying unit 5d compares the evaluation value of gender detected by the face feature detection unit 5c with a plurality of thresholds, and specifies that the object is male or female.

Further, in the case of race, for example, the object feature specifying unit 5d compares the evaluation value of the race detected by the face feature detection unit 5c with a plurality of thresholds, and specifies that the object is Caucasoid (white race), Mongoloid (yellow race), Negroid (black race), or the like. Further, the object feature specifying unit 5d may presume and specify the birthplace (country or region) from the specified race.

The movement condition setting unit 5e sets control conditions for moving the main parts.

That is, the movement condition setting unit 5e sets control conditions for moving the main parts detected by the face main part detection unit 5b, based on the features of the object specified by the object feature specifying unit 5d.

Specifically, the movement condition setting unit 5e sets, as control conditions, conditions for adjusting moving modes (for example, moving speed, moving direction, and the like) of the main parts detected by the face main part detection unit 5b. That is, the movement condition setting unit 5e reads and acquires the reference movement data 3b of a main part to be processed from the storage unit 3, and based on the features of the object specified by the object feature specifying unit 5d, sets, as control conditions, correction contents of information showing the movements of a plurality of control points for moving the main part included in the reference movement data 3b, for example. At this time, the movement condition setting unit 5e may set, as control conditions, conditions for adjusting the moving modes (for example, moving speed, moving direction, and the like) of the whole of the face including the main part detected by the face main part detection unit 5b. In that case, the movement condition setting unit 5e acquires the reference movement data 3b corresponding to all of the main parts of the face, and sets correction contents of information showing the movements of a plurality of control points corresponding to the respective main parts included in the reference movement data 3b thereof, for example.

For example, the movement condition setting unit 5e sets control conditions for allowing opening/closing movement of the mouth, or control conditions for changing the face expression, based on the features of the object specified by the object feature specifying unit 5d.

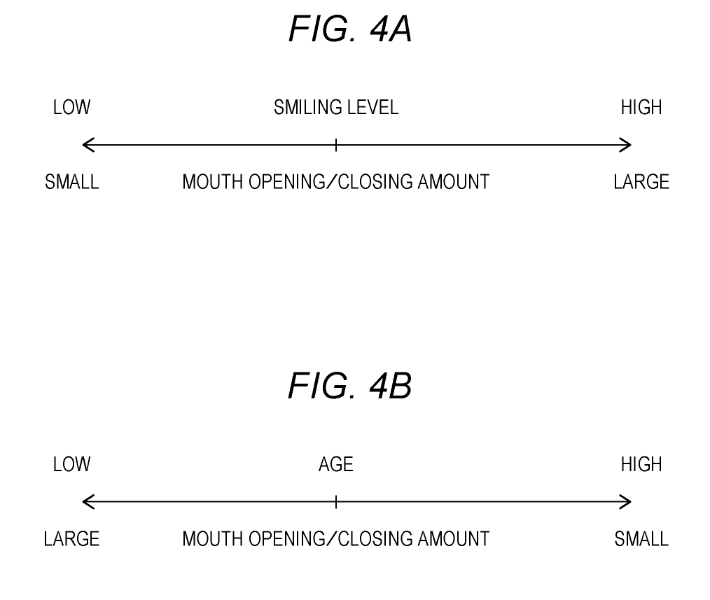

Specifically, in the case where a smiling level is specified as a feature of the object by the object feature specifying unit 5d, for example, the movement condition setting unit 5e sets correction contents of information showing the movements of a plurality of control points corresponding to the upper lip and the lower lip included in the reference movement data 3b, such that the opening/closing amount of the mouth is relatively larger as the smiling level is higher (see FIG. 4A).

Further, in the case where age is specified as a feature of the object by the object feature specifying unit 5d, the movement condition setting unit 5e sets correction contents of information showing the movements of a plurality of control points corresponding to the upper lip and the lower lip included in the reference movement data 3b, such that the opening/closing amount of the mouth is relatively smaller as the age (age group) is higher according to the segment to which the age belongs (see FIG. 4B). At this time, the movement condition setting unit 5e sets the respective correction contents of the information showing the movements of a plurality of control points included in the reference movement data 3b corresponding to all main parts of the face, for example, such that the moving speed when changing the face expression is relatively lower as the age is higher.

Further, in the case where gender is specified as a feature of the object by the object feature specifying unit 5d, for example, the movement condition setting unit 5e sets correction contents of information showing the movements of a plurality of control points corresponding to the upper lip and the lower lip included in the reference movement data 3b, such that the opening/closing amount of the mouth is relatively small in the case of a female while the opening/closing amount of the mouth is relatively large in the case of a male.

Further, in the case where the birthplace is presumed and specified as a feature of the object by the object feature specifying unit 5d, the movement condition setting unit 5e sets correction contents of information showing the movements of a plurality of control points corresponding to the upper lip and the lower lip included in the reference movement data 3b, such that the opening/closing amount of the mouth is changed according to the birthplace (for example, the opening/closing amount of the mouth is relatively large for an English-speaking region, and the opening/closing amount of the mouth is relatively small in the case of a Japanese-speaking region). In that case, it is also possible to prepare a plurality of units of reference movement data 3b for respective birthplaces beforehand, and the movement condition setting unit 5e may acquire the reference movement data 3b corresponding to the birthplace and set correction contents of information showing the movements of a plurality of control points corresponding to the upper lip and the lower lip included in such reference movement data 3b.

It should be noted that the control conditions set by the movement condition setting unit 5e may be output to a given storage unit (for example, the memory 2 or the like) and stored temporarily.

Further, the control content for moving the mouth as described above is an example, and the present invention is not limited thereto. The control content may be changed in any way as appropriate.

Further, while a mouth is exemplarily shown as a main part and a control condition thereof is set, it is an example, and the present invention is not limited thereto. For example, another main part such as eyes, nose, eyebrows, face contour, or the like may be used, for example. In that case, it is possible to set a control condition of another main part, while taking into account the control condition for moving the mouth.

That is, it is possible to set a control condition for moving a main part such as a nose or a face contour, which is near the mouth, in a related manner, while taking into account the control condition for allowing opening/closing movement of the mouth.

The movement generation unit 5f generates movement data for moving main parts, based on control conditions set by the movement condition setting unit 5e.

Specifically, based on the reference movement data 3b of a main part to be processed and a correction content of the reference movement data 3b set by the movement condition setting unit 5e, the movement generation unit 5f corrects information showing the movements of a plurality of control points and generates the corrected data as movement data of the main part. Further, in the case of adjusting the moving mode of the whole of the face, the movement condition setting unit 5e acquires the reference movement data 3b corresponding to all main parts of the face. Then, based on the correction contents of the reference movement data 3b set by the movement condition setting unit 5e, the movement condition setting unit 5e corrects the information showing the movements of the control points for each unit of the reference movement data 3b, and generates the corrected data as movement data for the whole of the face, for example.

It should be noted that the movement data generated by the movement generation unit 5f may be output to a given storage unit (for example, memory 2 or the like) and stored temporarily.

The movement control unit 5g moves a main part in a face image.

That is, the movement control unit (control unit) 5g moves a main part according to a control condition set by the movement condition setting unit 5e within the face image acquired by the image acquisition unit 5a. Specifically, the movement control unit 5g sets a plurality of control points at given positions of the main part to be processed, and acquires movement data of the main part to be processed generated by the movement generation unit 5f. Then, the movement control unit 5g performs deformation processing to move the main part by displacing the control points based on the information showing the movements of the control points defined in the acquired movement data.

Further, in the case of moving the whole of the face, the movement control unit 5g sets a plurality of control points at given positions of all main parts to be processed, and acquires movement data for the whole of the face generated by the movement generation unit 5f, almost similarly to the above-described case. Then, the movement control unit 5g performs deformation processing to move the whole of the face by displacing the control points based on the information showing the movements of the control points of the respective main parts defined in the acquired movement data.

The display unit 6 is configured of a display such as a liquid crystal display (LCD), a cathode ray tube (CRT), or the like, and displays various types of information on the display screen under control of the display control unit 7.

The display control unit 7 performs control of generating display data and allowing it to be displayed on the display screen of the display unit 6.

Specifically, the display control unit 7 includes a video card (not illustrated) including a graphics processing unit (GPU), a video random access memory (VRAM), and the like, for example. Then, according to a display instruction from the central control unit 1, the display control unit 7 generates display data of various types of screens for moving the main parts by face movement processing, through drawing processing by the video card, and outputs it to the display unit 6. Thereby, the display unit 6 displays a content which is deformed in such a manner that the main parts (eyes, mouth, and the like) of the face image are moved or the face expression is changed by the face movement processing, for example.

### Face Movement Processing

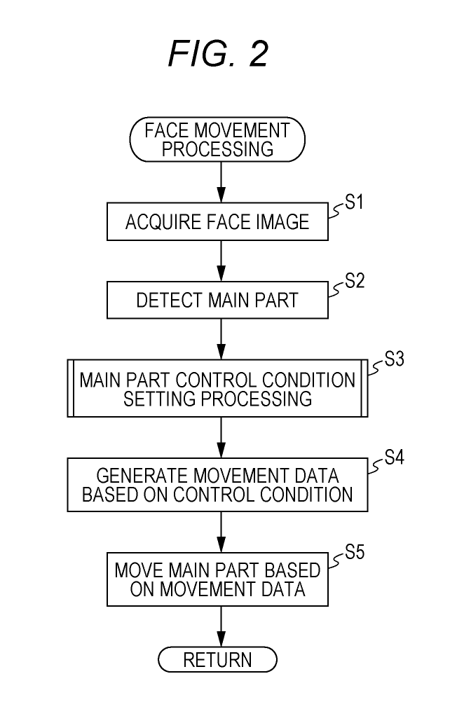

Next, face movement processing will be described with reference to FIGS. 2 to 4.

FIG. 2 is a flowchart illustrating an exemplary operation according to face movement processing.

As illustrated in FIG. 2, the image acquisition unit 5a of the movement processing unit 5 first acquires the face image data 3a desired by a user designated based on a predetermined operation of the operation input unit 4 by the user, among a given number of units of the face image data 3a stored in the storage unit 3 (step S1).

Next, the face main part detection unit 5b detects main parts such as right and left eyes, nose, mouth, eyebrows, face contour, and the like, through the processing using AAM, from the face image of the face image data acquired by the image acquisition unit 5a (step S2).

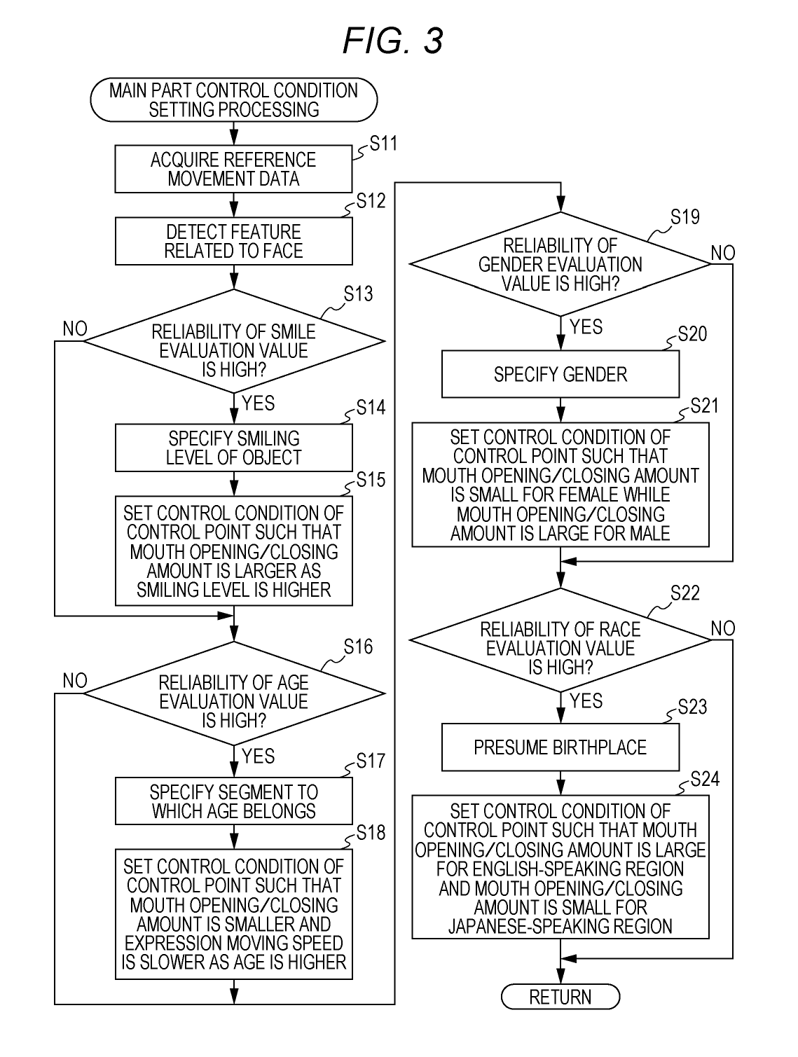

Then, the movement processing unit 5 performs main part control condition setting processing (see FIG. 3) to set control conditions for moving the main parts detected by the face main part detection unit 5b (step S3; details are described below).

Next, the movement generation unit 5f generates movement data for moving the main parts, based on the control conditions set in the main part control condition setting processing (step S4). Then, based on the movement data generated by the movement generation unit 5f, the movement control unit 5g performs processing to move the main parts in the face image (step S5).

For example, the movement generation unit 5f generates movement data for moving the main parts such as eyes and mouth based on the control conditions set in the main part control condition setting processing. Based on the information showing the movements of a plurality of control points of the respective main parts defined in the movement data generated by the movement generation unit 5f, the movement control unit 5g displaces the control points to thereby perform processing to move the main parts such as eyes and mouth and change the expression by moving the whole of the face in the face image.

### Main Part Control Condition Setting Processing

Next, the main part control condition setting processing will be described with reference to FIGS. 3 and 4.

FIG. 3 is a flowchart illustrating an exemplary operation according to the main part control condition setting processing. Further, FIGS. 4A and 4B are diagrams for explaining the main part control condition setting processing.

As illustrated in FIG. 3, the movement condition setting unit 5e first reads the reference movement data 3b of a main part (for example, mouth) to be processed, from the storage unit 3, and obtains it (step S11).

Next, the face feature detection unit 5c detects features related to the face from the face image acquired by the image acquisition unit 5a (step S12). For example, the face feature detection unit 5c performs a predetermined operation according to a lifting state of the right and left corners of the mouth, an opening state of the mouth, and the like to thereby calculate an evaluation value of a smile of the face, or extracts feature quantities from the face image, and from the feature quantities, calculates evaluation values of age, gender, race, and the like of an object (for example, human) respectively by applying a well-known estimation theory.

Then, the object feature specifying unit 5d determines whether or not the evaluation value of the smile detected by the face feature detection unit 5c has high reliability (step S13). For example, when calculating the evaluation value of the smile, the face feature detection unit 5c calculates the validity (reliability) of the detection result by performing a predetermined operation, and according to whether or not the calculated value is not less than a given threshold, the object feature specifying unit 5d determines whether or not the reliability of the evaluation value of the smile is high.

Here, if it is determined that the reliability of the evaluation value of the smile is high (step S13; YES), the object feature specifying unit 5d specifies a smiling level of the object having the face included in the face image, according to the detection result of the smile by the face feature detection unit 5c (step S14). For example, the object feature specifying unit 5d compares the evaluation value of the smile detected by the face feature detection unit 5c with a plurality of thresholds to thereby evaluate the smiling level relatively and specifies it.

Then, the movement condition setting unit 5e sets, as control conditions, correction contents of information showing the movements of a plurality of control points corresponding to the upper lip and the lower lip included in the reference movement data 3b such that the opening/closing amount of the mouth is relatively larger as the smiling level specified by the object feature specifying unit 5d is higher (see FIG. 4A) (step S15).

On the other hand, if it is determined at step S13 that the reliability of the evaluation value of the smile is not high (step S13; NO), the movement processing unit 5 skips the processing of steps S14 and S15.

Next, the object feature specifying unit 5d determines whether or not the reliability of the evaluation value of the age detected by the face feature detection unit 5c is high (step S16). For example, when the face feature detection unit 5c calculates the evaluation value of the age, the face feature detection unit 5c calculates the validity (reliability) of the calculation result by performing a predetermined operation, and according to whether or not the calculated value is not less than a predetermined threshold, the object feature specifying unit 5d determines whether or not the reliability of the evaluation value of the age is high.

Here, if it is determined that the reliability of the evaluation value of the age is high (step S16; YES), the object feature specifying unit 5d specifies the segment to which the age of the object having the face included in the face image belongs, based on the detection result of the age by the face feature detection unit 5c (step S17). For example, the object feature specifying unit 5d compares the evaluation value of the age detected by the face feature detection unit 5c with a plurality of thresholds to thereby specify the segment, such as infant, child, young, adult, elderly, or the like, to which the age belongs.

Then, according to the segment specified by the object feature specifying unit 5d, the movement condition setting unit 5e sets, as control conditions, correction contents of the information showing the movements of the control points corresponding to the upper lip and the lower lip included in the reference movement data 3b such that the opening/closing amount of the mouth is relatively smaller as the age is higher (see FIG. 4B). Further, the movement condition setting unit 5e sets, as control conditions, correction contents of the information showing the movements of the control points corresponding to all main parts of the face such that the moving speed when changing the face expression is slower (step S18).

On the other hand, if it is determined at step S16 that the reliability of the evaluation value of the age is not high (step S16; NO), the movement processing unit 5 skips the processing of steps S17 and S18.

Next, the object feature specifying unit 5d determines whether or not the reliability of the evaluation value of gender detected by the face feature detection unit 5c is high (step S19). For example, when the face feature detection unit 5c calculates the evaluation value of gender, the face feature detection unit 5c calculates the validity (reliability) of the calculation result by performing a predetermined operation, and according to whether or not the calculated value is not less than a predetermined threshold, the object feature specifying unit 5d determines whether or not the reliability of the evaluation value of gender is high.

Here, if it is determined that the reliability of the evaluation value of gender is high (step S19; YES), the object feature specifying unit 5d specifies gender, that is, female or male, of the object having the face included in the face image, based on the detection result of gender by the face feature detection unit 5c (step S20).

Then, according to gender specified by the object feature specifying unit 5d, the movement condition setting unit 5e sets, as control conditions, correction contents of the information showing the movements of the control points corresponding to the upper lip and the lower lip included in the reference movement data 3b such that the opening/closing amount of the mouth is relatively small in the case of a female while the opening/closing amount of the mouth is relatively large in the case of a male (step S21).

On the other hand, if it is determined at step S19 that the reliability of the evaluation value of gender is not high (step S19; NO), the movement processing unit 5 skips the processing of steps S20 and S21.

Next, the object feature specifying unit 5d determines whether or not the reliability of the evaluation value of the race detected by the face feature detection unit 5c is high (step S22). For example, when the face feature detection unit 5c calculates the evaluation value of the race, the face feature detection unit 5c calculates the validity (reliability) of the calculation result by performing a predetermined operation, and according to whether or not the calculated value is not less than a predetermined threshold, the object feature specifying unit 5d determines whether or not the reliability of the evaluation value of the race is high.

Here, if it is determined that the reliability of the evaluation value of the race is high (step S22; YES), the object feature specifying unit 5d presumes the birthplace of the object having the face included in the face image, based on the detection result of the race by the face feature detection unit 5c (step S23). For example, the object feature specifying unit 5d compares the evaluation value of the race detected by the face feature detection unit 5c with a plurality of thresholds to thereby specify the race, that is, Caucasoid, Mongoloid, Negroid, or the like, and presume and specify the birthplace from the specified result.

Then, according to the birthplace specified by the object feature specifying unit 5d, the movement condition setting unit 5e sets, as control conditions, correction contents of the information showing the movements of the control points corresponding to the upper lip and the lower lip included in the reference movement data 3b such that the opening/closing amount of the mouth is relatively large in the case of an English-speaking region, while the opening/closing amount of the mouth is relatively small in the case of a Japanese-speaking region (step S24).

On the other hand, if it is determined at step S22 that the reliability of the evaluation value of the race is not high (step S22; NO), the movement processing unit 5 skips the processing of steps S23 and S24.

It should be noted that the processing procedure of setting control conditions based on the smiling level, age, gender, and race of an object as features of the object in the main part control condition setting processing described above is an example, and the present invention is not limited thereto. The processing procedure can be changed in any way as appropriate.

As described above, according to the movement processing apparatus 100 of the present embodiment, features (for example, smiling level, age, gender, race, and the like) of an object having a face included in a face image are specified based on detection results of the features related to the face from the face image, and based on the specified features of the object, control conditions for moving the main parts (for example, mouth and the like) of the face are set. As such, it is possible to properly specify the feature (for example, smiling level or the like) of the object having the face while taking into account the features of the face (for example, features of mouth and eyes). Thereby, it is possible to allow appropriate movements corresponding to the features of the object according to the control conditions in the face image. Thereby, as local degradation of the image quality and unnatural deformation can be prevented, movements of the main parts of the face can be made more naturally.

Further, as control conditions for allowing the opening/closing movement of the mouth are set based on the features of an object having a face, the opening/closing movement of the mouth can be made more naturally, according to the control conditions set while taking into account the features of the object. That is, as conditions for adjusting the moving modes (for example, moving speed, moving direction, and the like) of a main part such as a mouth are set as control conditions, it is possible to adjust the moving modes of the main part while taking into account the features of the object such as smiling level, age, gender, and race, for example. Then, by moving the main part according to the set control conditions in the face image, the movement of the main part of the face can be made more naturally.

Further, as control conditions for changing the expression of a face including the main parts are set based on the features of the object having the face, the movements to change the expression of the face can be made more naturally according to the control conditions set while taking into account the features of the object. That is, as conditions for adjusting the moving modes (for example, moving speed, moving direction, and the like) of the whole of the face including the detected main parts are set as control conditions, it is possible to adjust the moving modes of all main parts to be processed, while taking into account the features of the object such as smiling level, age, gender, and race, for example. Then, by moving the whole of the face including the main parts according to the set control conditions in the face image, movements of the whole of the face can be made more naturally.

Further, by preparing the reference movement data 3b including information showing movements serving as the basis for representing movements of respective main parts of a face, and setting, as control conditions, correction contents of information showing the movements of a plurality of control points for moving the main pats included in the reference movement data 3b, it is possible to move the main parts of the face more naturally, without preparing data for moving the main parts of the face according to the various types of shapes thereof, respectively.

It should be noted that the present invention is not limited to the embodiment described above, and various modifications and design changes can be made within the scope not deviating from the effect of the present invention.

Further, while the embodiment described above is formed of a single unit of movement processing apparatus 100, this is an example and the present invention is not limited thereto. For example, the present invention may be applied to a projection system (not illustrated) for projecting, on a screen, a video content in which a projection target object such as a person, a character, an animal, or the like explains a product or the like.

Further, in the embodiment described above, the movement condition setting unit 5e may function as a weighting unit and perform weighting on control conditions corresponding to the respective features of objects specified by the object feature specifying unit 5d.

That is, in the case of performing switching between images of various models in a wide variety of age groups and allowing the main parts of the faces of the models to move while switching, by providing a large weight to a control condition corresponding to the age, it is possible to emphasize differences in age of the models.

Further, in the embodiment described above, while movement data for moving the main parts is generated based on the control conditions set by the movement condition setting unit 5e, this is an example and the present invention is not limited thereto. The movement generation unit 5f is not necessarily provided. For example, it is also possible that the control conditions set by the movement condition setting unit 5e are output to an external device (not illustrated), and that movement data is generated in the external device.

Further, while the main parts and the whole of the face are moved according to the control conditions set by the movement condition setting unit 5e, this is an example and the present invention is not limited thereto. The movement control unit 5g is not necessarily provided. For example, it is also possible that the control conditions set by the movement condition setting unit 5e are output to an external device (not illustrated), and that the main parts and the whole of the face are moved according to the control conditions in the external device.

Further, the configuration of the movement processing apparatus 100, exemplarily described in the embodiment described above, is an example, and the present invention is not limited thereto. For example, the movement processing apparatus 100 may be configured to include a speaker (not illustrated) which outputs sounds, and output a predetermined sound from the speaker in a lip-sync manner when performing processing to move the mouth in the face image. The data of the sound, output at this time, may be stored in association with the reference movement data 3b, for example.

In addition, the embodiment described above is configured such that the functions as an acquisition unit, a detection unit, a specifying unit, and a setting unit are realized by the image acquisition unit 5a, the face feature detection unit 5c, the object feature specifying unit 5d, and the movement condition setting unit 5e which are driven under control of the central control unit 1 of the movement processing apparatus 100. However, the present invention is not limited thereto. A configuration in which they are realized by a predetermined program or the like executed by the CPU of the central control unit 1 is also acceptable.

That is, in a program memory storing programs, a program including an acquisition processing routine, a detection processing routine, a specifying processing routine, and a setting processing routine is stored. Then, by the acquisition processing routine, the CPU of the central control unit 1 may function as a unit that acquires an image including a face. Further, by the detection processing routine, the CPU of the central control unit 1 may function as a unit that detects features related to the face from the acquired image including the face. Further, by the specifying processing routine, the CPU of the central control unit 1 may function as a unit that specifies features of an object having the face included in the image, based on the detection result of the features related to the face. Further, by the setting processing routine, the CPU of the central control unit 1 may function as a unit that sets control conditions for moving the main parts forming the face included in the image, based on the specified features of the object.

Similarly, as for a movement control unit and a weighting unit, they may be configured to be realized by execution of a predetermined program or the like by the CPU of the central control unit 1.

Further, as a computer-readable medium storing a program for executing the respective units of processing described above, it is also possible to apply a non-volatile memory such as a flash memory or a portable recording medium such as a CD-ROM, besides a ROM, a hard disk, or the like. Further, as a medium for providing data of a program over a predetermined communication network, a carrier wave can also be applied.

While some embodiments of the present invention have been described, the scope of the present invention is not limited to the embodiments described above, and includes the scope of the invention described in the claims and the equivalent scope thereof.

What is claimed is:

1. A movement processing apparatus comprising:
an acquisition unit configured to acquire an image including a face; and
a control unit configured to:
detect a feature related to the face from the image acquired by the acquisition unit;
specify a feature of an object having the face based on the detection result; and
set a control condition for moving a main part forming the face based on the specified feature of the object.

2. The movement processing apparatus according to claim 1, wherein
the control unit further specifies at least one of smiling level, age, gender, and race of the object.

3. The movement processing apparatus according to claim 2, wherein
the control unit further specifies a control condition for allowing opening and closing movement of a mouth as the main part.

4. The movement processing apparatus according to claim 1, wherein
the control unit further sets a condition for adjusting a moving mode of the main part as the control condition.

5. The movement processing apparatus according to claim 1, wherein
the control unit moves the main part according to the control condition in the image including the face acquired by the acquisition unit.

6. The movement processing apparatus according to claim 1, wherein
the control unit further sets a control condition for changing expression of the face including the main part.

7. The movement processing apparatus according to claim 6, wherein
the control unit further sets a condition for adjusting a moving mode of the whole of the face including the main part as the control condition.

8. The movement processing apparatus according to claim 6, wherein
the whole of the face including the main part is moved according to the control condition in the image including the face acquired by the acquisition unit.

9. The movement processing apparatus according to claim 1, wherein
the control unit specifies a plurality of features of the object, and performs weighting of the control condition for each of the specified features of the objects.

10. A movement processing method using a movement processing apparatus, the method comprising the steps of:
acquiring an image including a face;
detecting a feature related to the face from the acquired image ;
specifying a feature of an object having the face based on the detection result of the feature related to the face; and
setting a control condition for moving a main part forming the face based on the specified feature of the object.

11. A non-transitory computer-readable medium storing a program for causing a computer to execute:
acquisition processing to acquire an image including a face;
detection processing to detect a feature related to the face from the image acquired by the acquisition processing;
specifying processing to specify a feature of an object having the face based on the detection result of the detection processing; and
setting processing to set a control condition for moving a main part forming the face based on the feature of the object specified by the specifying processing.
